(19) United States
(12) Patent Application Publication
(10) Pub. No.: US 2016/0177176 A1
(43) Pub. Date: Jun. 23, 2016

(54) SCINTILLATOR

(71) Applicant: ISIS INNOVATION LIMITED, Oxford, Oxfordshire (GB)

(72) Inventors: Benjamin WINTER, Oxfordshire (GB); Mark BROUARD, Oxfordshire (GB); Simon-John KING, Oxfordshire (GB); Claire VALLANCE, Oxfordshire (GB)

(21) Appl. No.: 14/897,848

(22) PCT Filed: Jun. 12, 2014
(86) PCT No.: PCT/GB2014/051818

§ 371 Date: Dec. 11, 2015

(30) Foreign Application Priority Data
Jun. 12, 2013 (GB) 1310476.5

(51) Int. Cl. C09K 11/06; G01T 1/20; G21K 4/00

(52) U.S. Cl. CPC C09K 11/06; G21K 4/00; G01T 1/20; C09K 2211/1007; C09K 2211/1088; C09K 2211/1011; C09K 2211/1029

(57) ABSTRACT

A charged particle scintillator (1), the scintillator comprising an organic luminescent dye (3) which, in use, serves to convert impinging charged particles into light and the scintillator comprises a base (2), and the luminescent dye deposited on the base.

### TECHNICAL FIELD

The present invention relates generally to scintillators.

### BACKGROUND

It is known to use phosphor screens as scintillators for charged particle detection in fields such as high energy physics and chemical dynamics, as well as radiation detectors and display devices. However, use and production of phosphor screens present various drawbacks. Both fast response times and high brightness are desirable; however, one is usually obtained at the expense of the other. Furthermore, the manufacture of phosphor screens involves the handling of highly toxic substances, and the manufacturing process itself can be labour intensive.

Mindful of those issues we seek to provide an improved scintillator.

### SUMMARY

According to a first aspect of the invention there is provided a charged particle scintillator, the scintillator comprising an organic luminescent dye which, in use, serves to convert impinging charged particles into light and the scintillator comprises a base, and the luminescent dye deposited on the base.

The scintillator may comprise a scintillator screen.

The luminescent dye may be deposited onto the screen by way of sublimation.

The base may comprise a transparent substrate, such as glass, preferably provided with a conductive coating or layer.

The luminescent dye may be suitable for use as a laser dye.

The luminescent dye may comprise a mixture of a variety of organic luminescent dyes.

The scintillator may be suitable for use under non-vacuum conditions.

In use, the scintillator may be used to convert electrons to light, which can then be detected using photodiode, photomultiplier, camera, or other photodetector. The scintillator may be used to detect ions in the same way. High energy ions generate sufficient light to be seen with the photodetectors listed above. Lower energy ions will only produce a few photons, and a highly sensitive photodetector such as a single-photon avalanche diode (SPAD) is needed to detect them. Alternatively, low energy (few kV) ions may be detected by using one or more microchannel plates to convert each ion into a burst of electrons, which are then detected by the scintillator/photodetector. Note: an MCP stage can also be used to amplify a small electron signal for example, in night vision applications.

Advantageously, applications include, but are not limited to, ion imaging, night vision, radiation detection, high energy physics, medical imaging.

The scintillator may be suitable for use with a charged particle detection apparatus, such as a mass spectrometer or an ion imaging apparatus.

The scintillator may be suitable for use as a component of night vision apparatus.

According to a second aspect of the invention there is provided charged particle detection apparatus comprising the scintillator of the first aspect of the invention.

The charged particle detection apparatus may comprise a mass spectrometer or an ion imaging apparatus, and with application to particle physics, radiation detectors and medical imaging, for example.

According to a third aspect of the invention there is provided night vision apparatus comprising the charge particle detection scintillator of the first aspect of the invention.

According to a fourth aspect of the invention there is provide a method of charged particle detection comprising using the charged particle scintillator of the first aspect of the invention.

The above, and other, aspects of the invention may comprise one or more features disclosed in the detailed description and/or drawings.

### BRIEF DESCRIPTION OF THE DRAWINGS

Various aspects of the invention will now be described, by way of example only, with reference to the following drawings in which:

FIG. 1 is a side view of a charged particle scintillator,

FIG. 2 is a schematic view of an ion detection apparatus, and

FIG. 3 is a plot of recorded intensity versus applied voltage.

### DETAILED DESCRIPTION

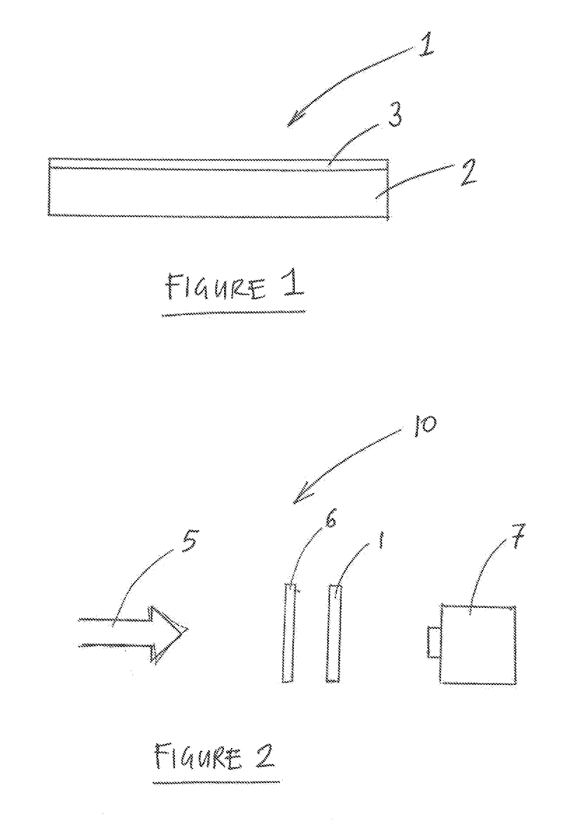

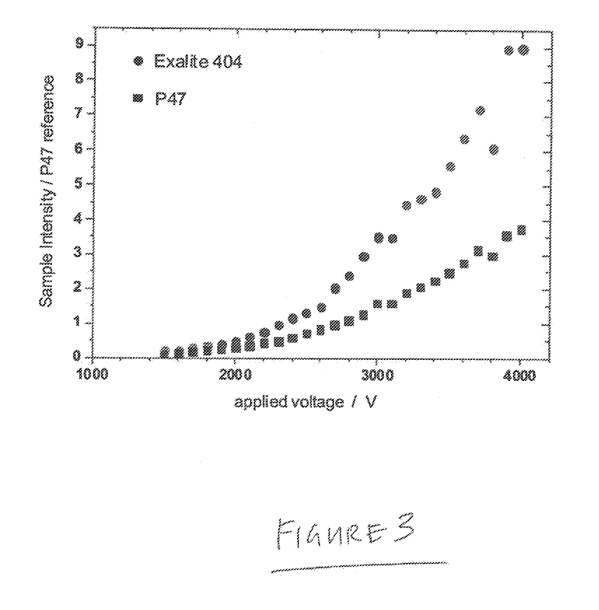

Reference is made initially to FIG. 1 which shows a charged particle scintillator 1. The scintillator comprises a base 2 and a layer of organic luminescent/fluorescent dye 3, based on an organic molecule. The luminescent/fluorescent dye may also be referred to herein as a radiant dye. The base 2 comprises a conductive transparent material such as an ITO coated glass substrate (such as a glass slide).

The scintillator 1 is produced by depositing, in a sublimation chamber, (pure) organic radiant dye onto the base 2. Advantageously, this production process ensures a high degree of control of thickness of the deposited layer of dye, and further ensures that the external surface of the dye layer, onto which charged particles impact, is smooth. It will be appreciated that other methods of applying/depositing the luminescent dye to the substrate could be employed, such as electrospray or chemical inkjet printing.

In use, the scintillator 1 is placed behind a micro channel plate (MCP) 6 of a charged particle detection apparatus 10. Accelerated charged particles 5 impacting the MCP 6 cause electrons to be emitted from the various channels of the MCP and impact the radiant dye of the scintillator and thereby initiate a scintillation event. The resulting photons which are emitted are detected by an imaging device 7, such as a camera. Advantageously, the photo-emission process is increased significantly without increasing the emission decay time such that the scintillator 1 is brighter than existing fast scintillators.

We have realised that luminescent dyes suitable or intended for use as a lasing medium can be used as the scintillation material when employed in a dye laser. Organic luminescent dyes are used as a liquid solution in which the dye is dissolved in a solvent. In relation to the scintillator 1, solid dye is sublimed onto the transparent conductive substrate. Examples of radiant dyes which could be used as a scintillation material include:

### Exalite 348

### Exalite 351

### Exalite 360

### Exalite 376

### Exalite 377E

### Exalite 384

### Exalite 389

### Exalite 392A

### Exalite 392E

### Exalite 398

### Exalite 400E

### Exalite 404

### Exalite 411

### Exalite 416

### Exalite 417

### Exalite 428

### Stilbene 3

### Coumarin 120

### Coumarin 152

### Coumarin 152A

### Coumarin 153

### Pyridine1/2

The chemical formulae of these compounds are given as follows:

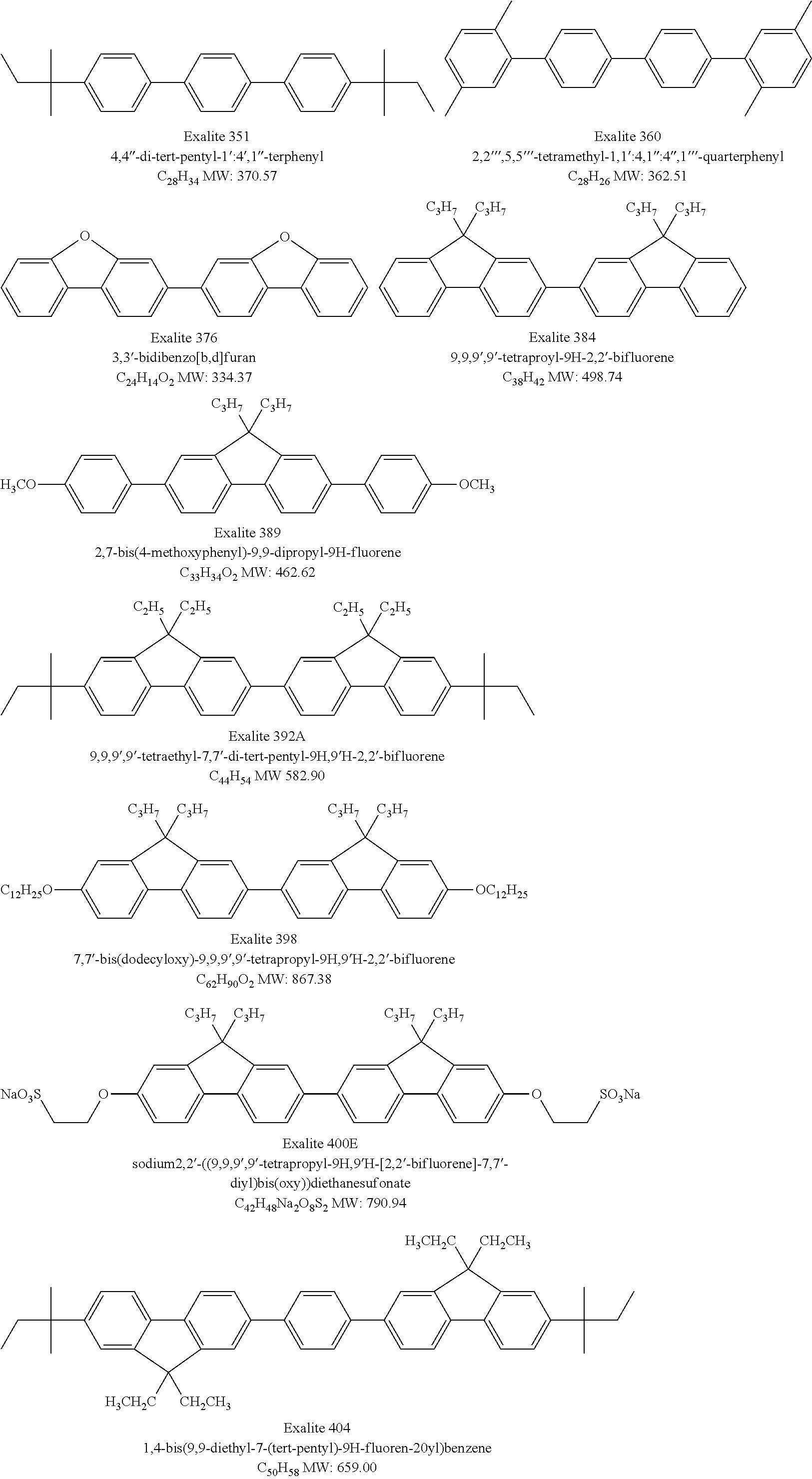

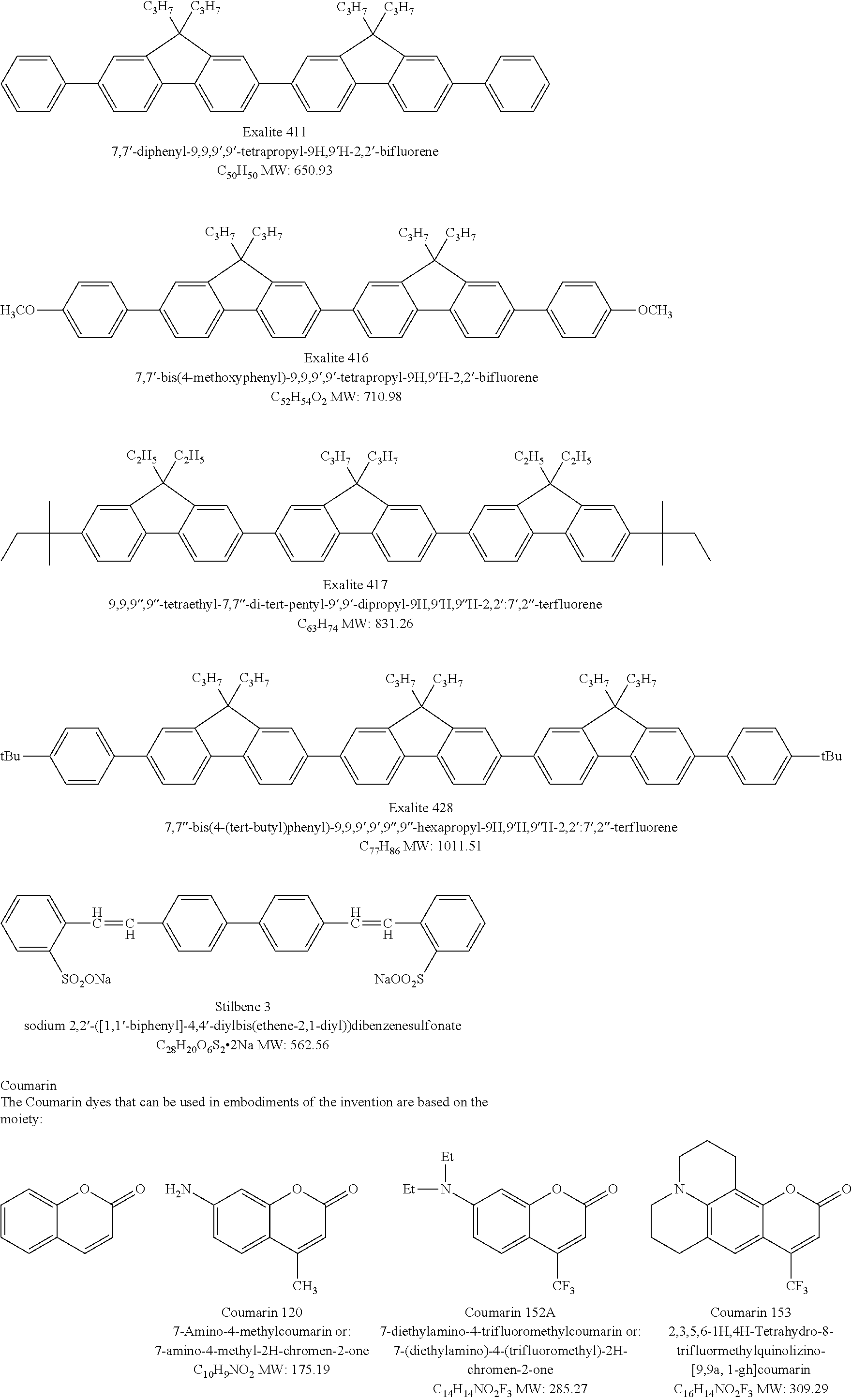

More generally, preferred molecular structures of suitable luminescent dyes can be classified as follows:

a. Derivatives of Poly-para-phenylene molecules (including different chain length)
b. Poly-para-phenylene molecules which may be substituted in the terminal positions of the chain
c. Poly-para-phenylene molecules in which adjacent benzene rings are additionally bridged in ortho-metha with a substituted and non-substituted methylene bridge
d. Poly-para-phenylene molecules in which adjacent benzene rings are additionally bridged with a substituted and non-substituted ethylene bridge
e. Poly-para-phenylene molecules in which adjacent benzene rings are additionally bridged via a connection containing a single atom (such as an oxygen atom)

MW stands for molecular weight.

Tests were conducted to compare the performance of a P47 phosphor screen and a scintillation detector of the type disclosed herein. It was found that signal intensity is greater for the detection scintillator 1 as compared to the phosphor screen, over the full range of accelerator potentials tested. It was also found that the organic scintillator has a significantly shorter decay lifetime (<8 ns, 100-10%) as compared to the commercially available P47 phosphor detector (˜100 ns). The tests were conducted using Exalite 404 as the radiant dye deposited onto an ITP-coated glass slide. FIG. 3 shows a plot of the results of the tests in which intensity is plotted against scintillator potential for each of the test samples.

A further important property of a detection scintillator is the spatial resolution. Tests were conducted to compare the spatial resolution achievable using the organic scintillator and the phosphor screen. To perform the tests, the screens were incorporated into position sensitive charged particles detectors and used to record images of photofragment velocity distributions in a chemical dynamics experiment. For an imaging detector spatial resolution is essential as any blurring of the image will severely limit its application. The analyses of the ring structures on the recorded images reveal very similar spatial intensity distributions, thus demonstrating no loss of spatial resolution for the organic scintillator relative to a P47 scintillator.

In order to test the application of such scintillators to direct ion detection, the detection scintillator 1 was placed in front of a multipixel photon counting (MPPC) detector comprising an array of SPAD (Single-Photon Avalanche Diodes) whose outputs are coupled in parallel. The resulting detector was mounted in the imaging apparatus described above. Ions were accelerated towards the detector and impacted the scintillator screen, thereby stimulating photon emission from the scintillation material. The resulting photons were discriminated and counted by the SPAD sensor with a pre-defined threshold setting.

The type of detection scintillator disclosed above may be used in any device requiring fast and efficient conversion of a charged particle into photons. Such scintillators may be used in mass spectrometric detectors involving the direct conversion of impacting charged particles into light which is then detected, with a fast photodetector. When an ion detector comprising the scintillator and a SPAD ion detector to an MCP-based detector. MCPs can only be operated at pressures below about 10e-5 Torr, while SPAD detectors can operate at any pressure. It will further be appreciated that accelerating ions to sufficient energy to activate the phosphor at high pressure may present a very real problem.

Although the scintillator above has been mentioned for use in relation to, for example, mass spectrometers, Daly detectors and ion imaging apparatus. The scintillator may also find application for use as a component in night vision devices to achieve brighter light collection, as compared to current systems. By combining a variety of organic dyes, each with a specific emission spectrum in the visible region and sensitivity. a particular emitted colour of the image may be produced in such devices. A further advantage is that the production cost of the scintillator could be lower as compared to the production cost of existing phosphor scintillators.

Further advantages of the detection scintillator above include the fact that no matrix is required, unlike some known scintillators which require a matrix (such as a plastics matrix) into which the scintillation material is embedded. Yet a further advantage is that in some circumstances, the need for an MCP may be avoided. Further advantageously, the detection scintillator can readily be made in bulk, easing the manufacturing process. However, notwithstanding the above, we have appreciated that a further aspect of the invention relates to use of organic luminescent dyes incorporated/dissolved into a matrix, in which the dye is in a proportion of at least 40% wt, and preferably at least 45% wt, and further still at least 50% wt.

1. A charged particle scintillator comprising an organic luminescent dye deposited on a base, wherein the organic luminescent dye is configured to convert impinging charged particles into light.

2. A scintillator as claimed in claim 1 comprising a scintillator screen.

3. A scintillator as claimed in claim 1 in which the luminescent dye is deposited onto the screen by way of sublimation.

4. A scintillator as claimed in claim 1 in which the base comprises a transparent substrate.

5. A scintillator according to claim 4, wherein the transparent substrate is provided with a conductive coating.

6. A scintillator as claimed in claim 1 in which the luminescent dye is suitable for use as a laser dye.

7. A scintillator as claimed in claim 1 in which the luminescent dye comprises a mixture of two or more organic luminescent dyes.

8. A scintillator as claimed in claim 1 in which the scintillator is suitable for use in a range of pressure conditions including vacuum conditions and non-vacuum conditions.

9. A scintillator as claimed in claim 1 which is suitable for use with an ion detection apparatus, such as a mass spectrometer or an ion imaging apparatus.

10. A scintillator as claimed in claim 1 configured for use as a component of night vision apparatus.

11. A charged particle detection apparatus comprising an ion detection scintillator of claim 1.

12. A charged particle detection apparatus as claimed in claim 11 which comprises a mass spectrometer or an ion imaging apparatus.

13. Night vision apparatus comprising the charge particle detection scintillator of claim 1.

14. A method of charged particle detection comprising using the ion detection scintillator of claim 1.

15. A method of producing a charged particle scintillator comprising depositing an organic luminescent dye on a base.
